(19) United States
(12) Patent Application Publication
(10) Pub. No.: US 2010/0051729 A1
(43) Pub. Date: Mar. 4, 2010

(54) REAR IMPLEMENT FOR A VEHICLE AND METHOD OF EXCHANGING REAR IMPLEMENTS

(75) Inventor: Douglas E. Schneider, Strasburg, IL (US)

Correspondence Address: VEDDER PRICE P.C., 222 N. LASALLE STREET, CHICAGO, IL, 60601, US

(73) Assignee: AGRI-FAB, INC., Sullivan, IL (US)

(21) Appl. No.: 12/203,381

(22) Filed: Sep. 3, 2008

(51) Int. Cl. A01C 14/00; B60D 1/00

(52) U.S. Cl. 239/661; 280/495; 280/769; 280/760

(57) ABSTRACT

This disclosure relates to a rear-removable attachment for a lawn and garden vehicle such as a residential zero-turn rider, and more specifically, to an attachment system made with two parallel fixation plates with a two-point hook-up where one point is locked in position and the second is slideably connected in the plates before the first point is locked. The attachment interface allows for the connection and removal of different attachments such as a bumper, a spreader, or any other lawn and garden equipment.

### BACKGROUND

This disclosure relates to a removable implement for a lawn and garden vehicle, and more specifically, to an interface for the connection and removal of different implements such as a bumper, a spreader, or any other lawn and agricultural equipment, and a method of exchanging rear implements.

### BACKGROUND

In rural and urban environments, lawns and other outdoor surfaces often require care. Weather conditions and extraneous uses can compact, damage, or upturn surfaces; branches or thatch can accumulate over parts of the surface; rocks can resurface over time; and dead branches, twigs, or man-made debris can collect over parts of the surface. Lawns grow and require constant attention. Different tools exist in the marketplace to care for these surfaces.

Understandably, if a small surface requires care, and a great degree of precision in the work to be performed is required, handheld devices may be best suited for this task. For intermediately sized parcels, devices can be attached to small, portable frames moved over the ground by a walking operator by pushing or pulling a handlebar. In some cases, lawnmowers are attached to small frames to enable precise movement around obstacles. When even greater precision is needed but the surface cannot be cared for rapidly using manual means, vehicles such as zero-turn riders can be used. These riders are equipped with a degree of mobility that allows for the rotation of the front portion of the frame around a back wheel without the need for longitudinal movement (i.e., a zero-turn rider is a vehicle that rotates with zero advancement).

A user sits on a seat positioned above the center of gravity and holds two opposing handles. Intuitively, by pushing both handles the vehicle moves forward, by pulling both handles the vehicle moves backwards, by moving one hand forward the vehicle rotates around the static side, and by moving one hand forward and the other back the vehicle rotates in place.

Vehicles designed for residential use must be adapted to use equipment directed to typical residential lawn care. Zero-turn riders are compact, and because of their ability to rotate, require perfect 360 degree visibility during operation. In addition, the degree of maneuverability associated with zero-turn rotation is incompatible with all forms of known towing attachment to the rear of the zero-turn rider. For example, a male hitch generally in the shape of a ball can be attached to or behind the back bumper and can be made to pivot within a spherical female attachment. Such systems, when used on zero-turn riders, do not allow the attachment to be moved when the rider rotates in place, and these attachments impact the wheels as the rider moves. As a consequence, users can only operate zero-turn riders by avoiding use of the zero-turn capacity of the vehicles when an attachment is in tow.

What is needed is a method of manually attaching and exchanging a removable attachment to a zero-turn rider without hindering the maneuverability of the vehicle or the attachment.

### SUMMARY

This disclosure relates to a removable implement for a lawn and garden vehicle such as a residential zero-turn rider, and more specifically, to an implement adaptation system made with two parallel fixation plates with a two-point hook-up where one point is locked in position and the second is slideably connected in the plates before the first point is locked. The attachment interface allows for the connection and removal of different implements such as a bumper, a spreader, or any other lawn and garden equipment.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is an isometric view of the rear end of a residential zero-turn rider with a spreader with the removable implement and a bumper implement equipped with the rear removable implement fixation plates according to an embodiment of the present disclosure.

FIG. 2 is an isometric view of the spreader implement equipped with fixation plates as shown in FIG. 1 according to an embodiment of the present disclosure.

FIG. 3 is an isometric view of the bumper implement equipped with fixation plates as shown in FIG. 1 according to an embodiment of the present disclosure.

FIG. 4 is an isometric view of the fixation plates of the removable implement as shown in FIG. 1 according to an embodiment of the present disclosure.

FIG. 5 is a top view of the spreader implement of FIG. 2.

FIG. 6 is a top view of the bumper implement of FIG. 3.

FIG. 7 is a diagram illustrating the method for exchanging a removable attachment on a vehicle according to an embodiment of the present disclosure.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

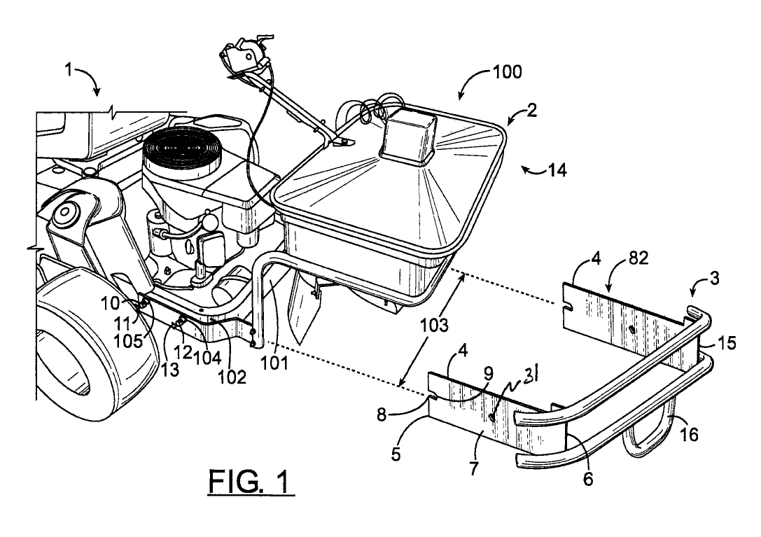

As shown in FIG. 1, a removable implement 100, such as, for example, a bumper 3 or a spreader 2, is adapted for use in connection with a vehicle 1 such as a zero-turn rider using a pair of substantially parallel fixation plates 82 separated by a fixed width 103. While two different implements 100 are shown, the attachment of any of a plurality of other implements that can be useful for operators of the vehicle 1 is contemplated. For example, if the operator is a novice or if there is an substantial risk of damage to the vehicle 1, a bumper 3 or other type of structural protection can be used. The spreader 2, in turn, represents one of a very large variety of agricultural implement, including the bumper 3, that can be attached to the vehicle 1 and used by an operator of a zero-turn rider to perform operations over a given lawn surface.

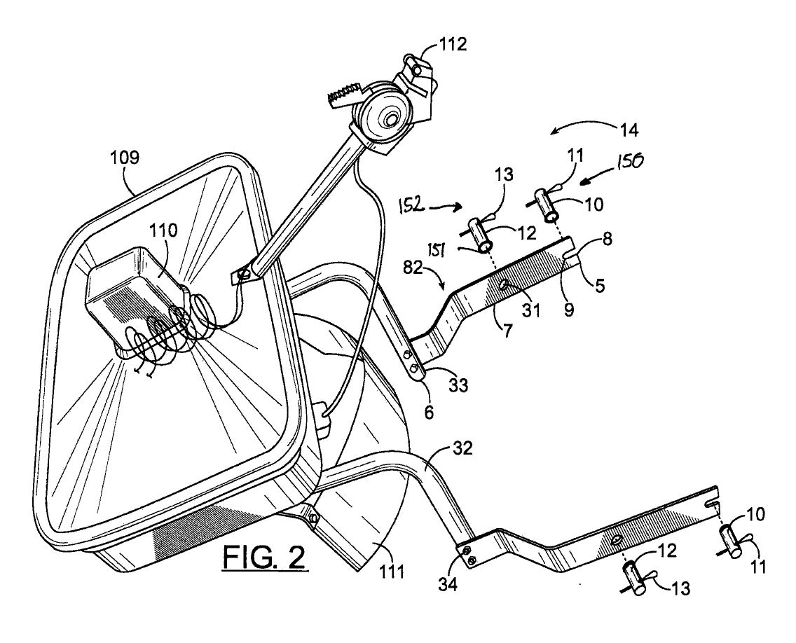

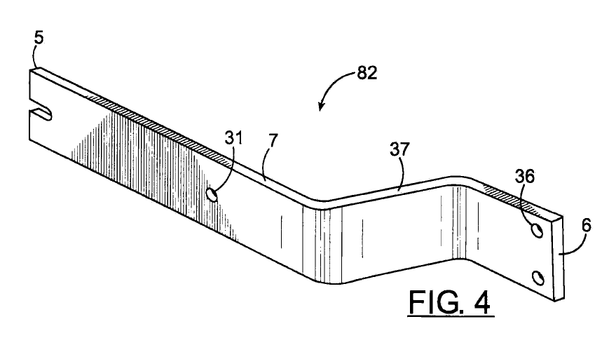

To facilitate the installation of the removable implement 100, as shown with greater particularity in FIG. 4, each plate 82 includes a front end 5 having an edge 8 and a lock 9 defined in the edge 8, a back end 6 and having a connector 33 as shown on FIG. 2, defined therein and disposed in opposition to the front end 5, and a middle portion 7 defined between the front end 5 and the back end 6 and having a pivot as an opening 31 defined therein.

Two different types of fixation plates 82 are shown in FIG. 1: a flat plate to attach the bumper 3 and a bent plate to attach the spreader 2. As shown, these plates are made of a flattened metal of sufficient stiffness and thickness to hold the structure connected to the back end 6 without bending while under operating conditions. While metal plates are contemplated, plates, bars, cylindrical tubes made of other material with sufficient rigidity to hold the removable implement 100 is contemplated.

The bend in the plate 82 of the spreader 2 allows for the connection of the spreader 2 having a small body to the location on which it is attached. While flat plates are shown for both removable implements 100, any structural elements, such as bars, profiles, tubes, or molded parts, can be used. The plates 82 at their front end 5 include an edge 8 with a notch 9 in the edge 8, and the middle portion 7 includes an opening 31. The spreader as shown in FIG. 2 includes a motor with cover 110, a reservoir for the material to be spread 109, a protective skirt 111, and a command mechanism 112 accessible by the operator of the vehicle 1.

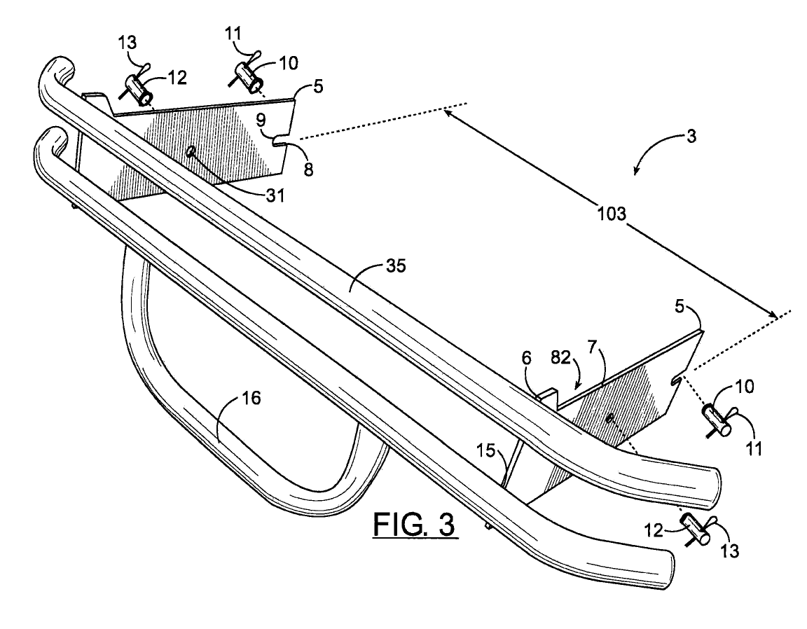

The removable attachment 100 also includes an agricultural implement 14 with a mounting frame 32 connected thereto, wherein the frame 32 includes a pair such as an L-shaped tube for the spreader 2 or two horizontal tubes 35 with a U-shaped bottom tube 16 for the bumper 3 as shown in FIG. 3. The mounting frame 32 as shown in FIG. 2 is coupled to the pair of fixation plates 82 at the connector 33. The mounting frame 32 is shown to be connected to the plates 82 with bolts 34 located at the end of the frame 32. The mounting frame 32 pan be made of two horizontal tubes 35 of the bumper 3 is welded to the plates 82 (not shown). While bolts and welds are shown, the use of any fixation means, such as locks, clips, L-shaped tabs, magnets, or the like, is contemplated.

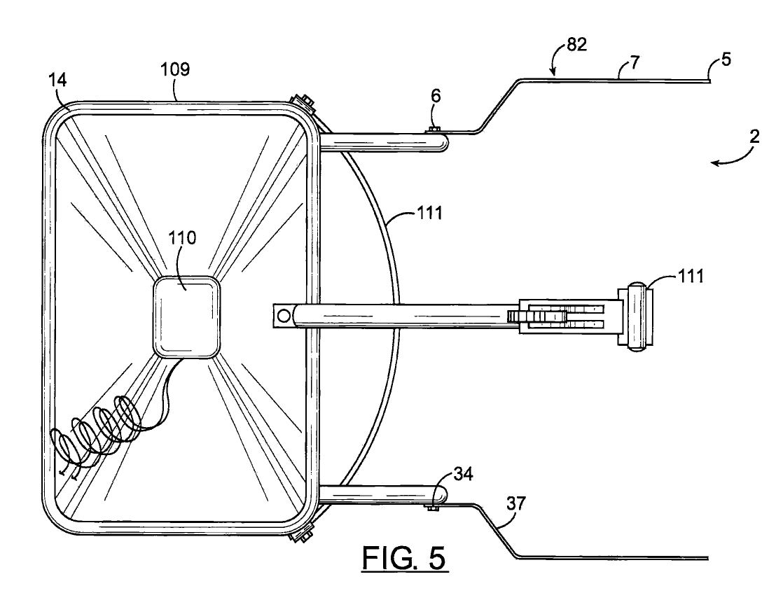

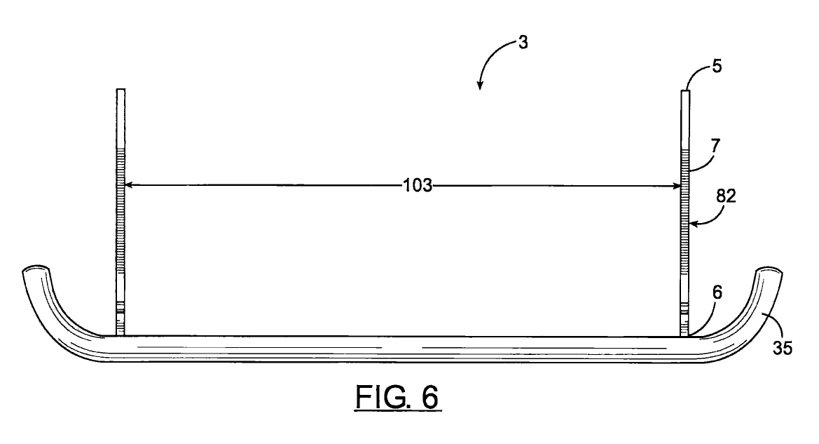

The frame 32, 35 is connected to the back ends 6 of the fixation plates 82. The fixation plates 82 are then secured at two different positions to the rear end of a vehicle. As shown in one embodiment, the vehicle 1 is not designed to receive the removable implement 100 and must be adapted. The simplest adaptation is to drill two sets of holes, each set to align with one of the two fixation means in the fixation plates 82. A vehicle 1 could also come with a fixation means, such as a protruding rod, a clip, a snap fit, or even a slide-in tab, to facilitate connection. In the embodiments shown in FIGS. 1-6, the vehicle 1 is not preadapted to receive implement 100.

The lock 9 includes a notch extending from the edge 8 and a locking assembly 150 including a lock pin 10 having a through bore at a first end and an enlarged portion at a second end or an end that can be secured using other means such as fillets, a pin, a tab, in opposition to the first end, such as in the case where a bolt or a head is used and a first securing element 11 such as a small metal pin for removably engaging the through bore in a selectively locking manner. The lock pins 10 can be portions of the vehicle 1 extruded from the surface or any other type of fixed pin.

The pivot 31 includes an opening and a pivot assembly 151 including a pivot pin 12 having a through bore at a first end, and an enlarged portion at a second end or an end that can be secured using other means such as fillets, a pin, a tab, or the like, in opposition to the first end, such as in the case where a bolt or a head is used and a second element for removably engaging the through bore in a selectively locking manner.

One of the advantages of this dual-point locking system is to simplify installation and exchange of two implements 100 while offering tolerances at the time of installation of the implements compatible with the large tolerances needed in the field of lawn, agricultural, and garden equipment. In one embodiment, the notch 9 is U-shaped to adapt with a cylindrical lock pin 10.

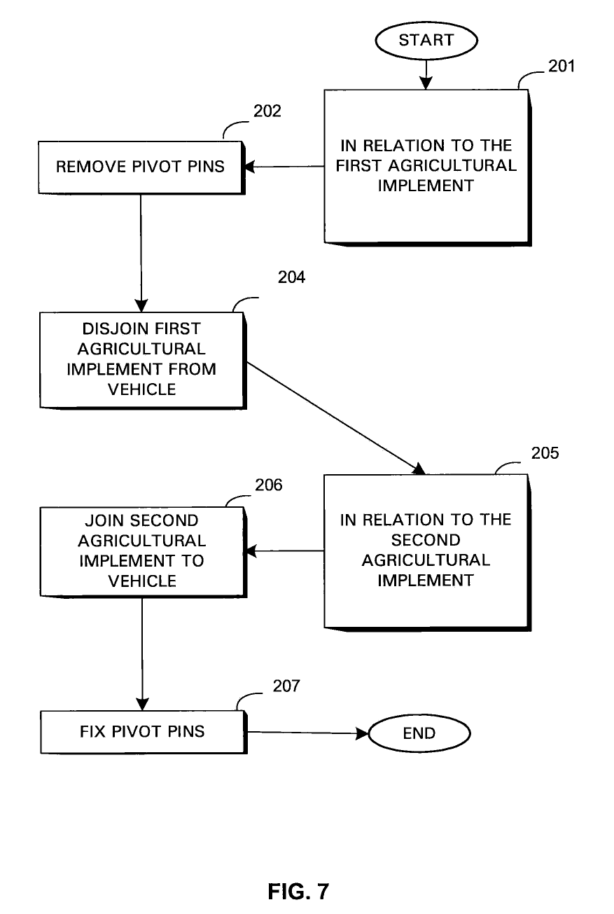

In another embodiment shown as FIG. 7, a method for exchanging a removable implement 100 adapted for use in connection with a vehicle 1 includes the steps of in relation to a first 14 agricultural implement 201 mounted on a vehicle 1, where pivot pins 12 are in the openings each in a pivot 31 in the middle portion 7 of a pair of substantially parallel fixation plates 82 separated by a width 103, the middle portion 7 defined between a front end 5 and a back end 6, each plate 82 including the front end 5 having an edge 8 and a lock 9 defined in the edge 8, the back end 6 having a connector 33 defined therein and disposed in opposition to the front end 5, wherein the lock 9 includes a notch extending from the edge 8 and a locking assembly 150 including a lock pin 10 having a through bore at a first end and an enlarged portion at a second end in opposition to the first end and a first securing element for removably engaging the notch in a selectively locking manner, and wherein the pivot 31 includes an opening and a pivot assembly 151 including a pivot pin 12 having a through bore at a first end, and an enlarged portion at a second end in opposition the first end and a second element for removably engaging the through bore in a selectively locking manner, and disjoining 204 the first agricultural implement 14 from the vehicle.

And in relation to a second 14 agricultural implement 205, attaching or joining 206 the second agricultural implement 14 as shown in FIG. 1, to the vehicle 1 by placing the second agricultural implement 14 on the vehicle 1, and fixing 207 the pair of pivot pins 12 in the openings of the pivot 31 of the middle section 7 of the fixation plates 82.

It is understood that the preceding is merely a detailed description of some examples and embodiments of the present invention and that numerous changes to the disclosed embodiments can be made in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

What is claimed is:

1. A removable implement adapted for use in connection with a vehicle, comprising:
a pair of substantially parallel fixation plates separated by a width, each plate including a front end having an edge and a lock defined in the edge, a back end having a connector defined therein and disposed in opposition to the front end, and a middle portion defined between the front end and the back end and having a pivot defined therein; and
an agricultural implement including a mounting frame connected thereto, wherein the frame is coupled to the pair of fixation plates at the connector of each fixation plate,
wherein the lock includes a notch extending from the edge and a locking assembly including a lock pin having a through bore at a first end and an enlarged portion at a second end in opposition to the first end and a first securing element for removably engaging the through bore in a selectively locking manner,
wherein the pivot includes an opening and a pivot assembly including a pivot pin having a through bore at a first end, and an enlarged portion at a second end in opposition the first end and a second element for removably engaging the through bore in a selectively locking manner, and
wherein the implement is removably connected to a vehicle by fixing the bore through the lock pin in the notch, and the bore through the pivot pin in the opening of the pivot.

2. The removable implement adapted for use in connection with a vehicle of claim 1, wherein the connector is a weld to attach the mounting frame to the back end of the fixation plates.

3. The removable implement adapted for use in connection with a vehicle of claim 1, wherein the connector is a threaded fastener to attach the mounting frame to the fixation plates.

4. The removable implement adapted for use in connection with a vehicle of claim 1, wherein the opening of the pivot is a circular opening.

5. The removable implement adapted for use in connection with a vehicle of claim 1, wherein the mounting frame is part of a bumper.

6. The removable implement adapted for use in connection with a vehicle of claim 1, wherein the mounting frame is part of a spreader.

7. The removable implement adapted for use in connection with a vehicle of claim 1, wherein the agricultural implement is a bumper.

8. The removable implement adapted for use in connection with a vehicle of claim 1, wherein the agricultural implement is a spreader.

9. The removable implement adapted for use in connection with a vehicle of claim 1, wherein the notch is U shaped.

10. A method for exchanging a removable implement adapted for use in connection with a vehicle comprising the steps of:
in relation to a first agricultural implement mounted on a vehicle, removing a pair of pivot pins from openings each in a pivot in the middle portion of a pair of substantially parallel fixation plates separated by a width, the middle portion defined between a front end and a back end, each plate including the front end having an edge and a lock defined in the edge, the back end having a connector defined therein and disposed in opposition to the front end, wherein the lock includes a notch extending from the edge and a locking assembly including a lock pin having a through bore at a first end and an enlarged portion at a second end in opposition to the first end and a first securing element for removably engaging the notch in a selectively locking manner, and wherein the pivot includes an opening and a pivot assembly including a pivot pin having a through bore at a first end, and an enlarged portion at a second end in opposition the first end and a second element for removably engaging the through bore in a selectively locking manner, and disjoining the first agricultural implement from the vehicle; and
in relation to a second agricultural implement, attaching the second agricultural implement to the vehicle by placing the second agricultural implement on the vehicle, fixing the pair of pivot pins in the openings of the pivot of the middle section of the fixation plates.
